(19) United States
(12) Patent Application Publication
(10) Pub. No.: US 2011/0276230 A1
(43) Pub. Date: Nov. 10, 2011

(54) Method for operating a power steering mechanism

(76) Inventors: Arnulf Heilig, Schwaebisch Gmuend (DE); Stefan Gruener, Auenwald (DE); Michael Sprinzl, Suessen (DE)

(21) Appl. No.: 13/134,469

(22) Filed: Jun. 8, 2011

Related U.S. Application Data
(63) Continuation of application No. PCT/EP2009/066299, filed on Dec. 3, 2009.

(30) Foreign Application Priority Data
Jan. 13, 2009 (DE) 10 2009 000 165.4

(51) Int. Cl. B62D 5/04; B62D 6/08; H02P 6/08

(52) U.S. Cl. 701/42; 318/434

(57) ABSTRACT

A method is disclosed for operating a power steering system in which a motor torque is computed by an electronic processor and established by suitable motor actuation, wherein a plausibility check is carried out for the computed motor torque as part of a 3-level design, wherein integration of a part above a motor torque limit curve and decrementation of an integrator with a part below the motor torque limit curve are performed, the target motor torque being limited to a first integration threshold in level 1, and the limitation is monitored in level 2, with an intrinsically safe motor torque limit curve being used as a function of an actual torque.

The invention relates to a method for operating a power steering system, to such a power steering system, and to a computer program and a computer program product for carrying out the method.

Power steering systems or servomechanisms are used to reduce the force required for actuating the steering wheel of a motor vehicle when steering while stationary, when maneuvering or while driving. In electric or electromechanical power steering systems (EPS: electric power steering), a target motor torque is computed for the EPS motor in a manner that is functionally dependent on various components, and is established by way of motor-current control.

It is known to employ power steering systems comprising control units that have a processor, comprising an intelligent safety processor, which is also referred to as a watchdog. What is referred to as the three-level design has been successfully applied for processor plausibility checking.

To detect computing errors, the essential steering functions are computed in temporally and functionally diverse manners, and the results are compared. This is intended to prevent potential errors from leading to safety-critical driving situations.

The method presented is used to operate a power steering system, wherein a motor torque is computed by an electronic processor and established by suitable motor actuation. A plausibility check for the computed motor torque is carried out within the scope of a three-level design. Moreover, an intrinsically safe motor torque limit curve is used, as a function of an actual torque, for example an actual manual torque or a driver torque. To this end, integration of a part above a motor torque limit curve and decrementation of an integrator with a part below the motor torque limit curve are performed. The target motor torque is limited, in level 1, to a first integration threshold, and the limitation is monitored in level 2.

According to an embodiment of the method, the monitoring limits are broadened under the following conditions:

generator operating state of the motor and motor speed above a certain rotational speed.

To this end, the power steering system can be switched into a safe state when a predefined threshold is exceeded in level 2. This may mean that the system is deactivated.

In an embodiment, the upper or lower limits are broadened only if the direction of rotation is correct. In addition, it is possible to broaden the upper or lower limits only starting from a certain motor torque.

Because the motor torque limit curve is vehicle-dependent, the application should be determined by road tests. The goal is for all operating states within the motor torque limit curve to be intrinsically safe, which is to say to remain controllable for the average driver.

The motor vehicle power steering system presented is notably used to carry out the method described above, and comprises:

an electric motor for introducing a predefined additional torque so as to arbitrarily influence steering torque;

a device for acquiring a current manual torque;

a device for acquiring variables for the electric motor;

a device for acquiring a rotor position; and

an electronic control unit for actuating the motor, which is adapted to compute a target motor torque, so that a desired actuating torque is established at the steering handle. To this end, control deviation between the target and actual actuating torques can be minimized by computing a target motor torque, which can be established by suitable motor actuation, for example by current control.

The power steering system can further comprise a microprocessor, which communicates with a safety processor.

In addition, a control unit is described, which is designed, in particular, for use in a power steering system of the type described above and is used to actuate an electric motor. This control device is adapted to compute a target motor torque, so that a desired actuating torque is established at the steering handle. To this end, control deviation between the target and actual actuating torques can be minimized by computing, for example, a controlled target motor torque, which can be established by suitable motor actuation.

The method presented can be used, at least in some of the described embodiments, to detect, in a sufficiently rapid manner, safety-critical faulty actuations, which are caused, for example, by microprocessor computing errors, so that the steering system can be switched into the safe state before safety-critical effects occur for the vehicle and the occupants. The function presented can be incorporated in the safety design of existing EPS systems with a processor.

Monitoring is principally performed by observing the combination of manual torque and motor torque. Optionally, instead of the manual torque or torsion-bar torque, driver torque can be used, which is to say the torque that the driver feels on the steering wheel, which is computed from the manual torque (torsion bar torque) with compensation for inertia influences on steering wheel torque. To this end, the combinations permitted in the function path (level 1) are limited, so as to ensure high robustness. Moreover, this design monitors the entire system behavior of the power steering system, so that monitoring of individual functions is no longer required. In this way, the safety verification process is also simplified.

A computer program comprises program code means for carrying out all the steps of a method, as described above, when the computer program is executed on a computer or a corresponding processor.

A computer program product comprises these program code means, which are stored on a computer-readable data medium.

This computer program can be stored on a computer-readable data medium, such as a diskette, CD, DVD, hard drive, USB memory stick or the like, or on an Internet server, as a computer program product. From there, the computer program can be transferred to a storage element of the control unit.

Further advantages and embodiments of the invention will be apparent from the description and the accompanying drawings.

The above characteristics and those described below can, of course, be used, not only in the respectively described combinations, but also in other combinations, or alone, without departing from the scope of the present invention.

The invention is schematically illustrated in the drawings based on an exemplary embodiment and will be described in detail hereinafter with reference to the drawings.

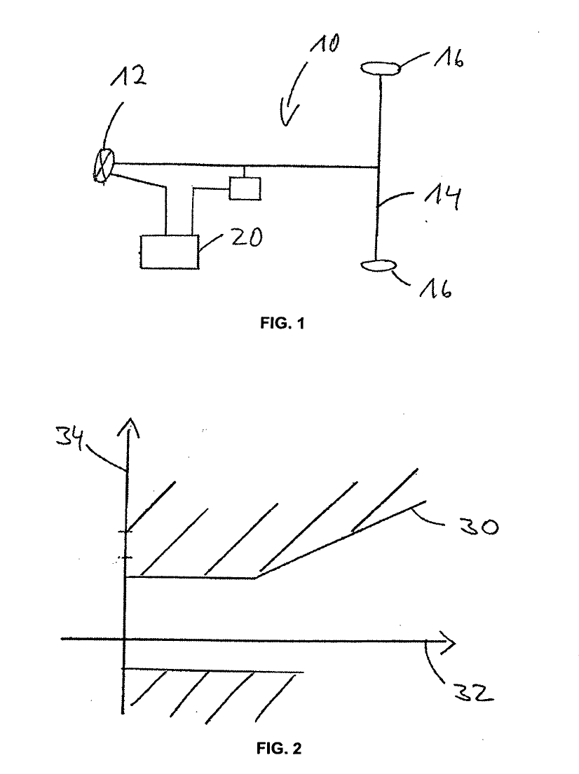

FIG. 1 shows an embodiment of the power steering system according to the invention.

FIG. 2 shows a graph of the course of the motor torque limit curve, serving to illustrate the method according to the invention.

FIG. 1 illustrates an embodiment of the power steering system which, in the overall, is denoted by reference numeral 10. The illustration shows a steering handle 12, a front axle 14 having two articulated wheels 16, an electric motor 18, and a control unit 20.

FIG. 2 shows a graph of the course 30 of the motor torque limit curve. The actual manual torque is plotted on an abscissa 32 and the motor torque on an ordinate 34.

When the motor torque reaches the hatched area, the part above the limit curve 30 is integrated. When the integrator reaches an adjustable threshold A, the motor torque is limited to the limit curve 30 in level 1. If, for example due to a computing error, the limitation were not performed correctly in level 1, the diverse algorithm in level 2 detects this at a threshold B, and can deactivate the system. |B|>|A| applies.

1. A method for operating a power steering system in which comprising computing a motor torque by an electronic processor and established by suitable motor actuation, performing a plausibility check for the computed motor torque as part of a three-level design, wherein integration of a part above a motor torque limit curve and decrementation of an integrator with a part below the motor torque limit curve are performed, the target motor torque being limited to a first integration threshold in level 1 and the limitation being monitored in level 2, and using an intrinsically safe motor torque limit curve as a function of an actual torque.

2. The method according to claim 1, wherein the monitoring limits are broadened under the conditions that the generator operating state of the motor and motor speed are above a certain rotational speed.

3. The method according to claim 1, wherein the power steering system is switched into a safe state when a threshold is exceeded in level 2.

4. A method according to claim 1, wherein the upper or lower limits are broadened only if the direction of rotation is correct.

5. A method according to claim 1, wherein the upper or lower limits are broadened only starting from certain motor torques.

6. A method according to claim 1, wherein the motor torque limit curve is determined by road tests so as to demonstrate the intrinsic safety of the limit curve.

7. A power steering system for a motor vehicle for carrying out a method according to claim 1, comprising:
an electric motor for introducing a predefined additional torque so as to arbitrarily influence steering torque;
a device for acquiring a current manual torque;
a device for acquiring variables for the electric motor;
a device for acquiring a rotor position; and
an electronic control unit for actuating the motor that is adapted to compute a target motor torque so that a desired actuating torque is established at a steering handle,
wherein the control unit is designed to minimize a control deviation between the target and actual actuating torques by computing a target motor torque which can be established by suitable motor actuation.

8. The power steering system according to claim 7, further comprising a microprocessor which communicates with a safety processor.

9. A control unit for use in a power steering system according to claim 7, which is used to actuate an electric motor and is adapted to compute a target motor torque so that a desired actuating torque is established at the steering handle, wherein the control unit is designed to minimize a control deviation between the target and actual actuating torques by computing a target motor torque, which can be established by suitable motor actuation.

10. A computer program comprising program code means for carrying out all the steps of a method according to claim 1, when the computer program is executed on a computer or a corresponding processor.

11. A computer program product comprising program code means, which are stored on a computer-readable data medium, for carrying out all the steps of a method according to claim 1, when the computer program is executed on a computer or a corresponding processor.

12. The method according to claim 2, wherein the power steering system is switched into a safe state when a threshold is exceeded in level 2.

13. A method according to claim 2, wherein the upper or lower limits are broadened only if the direction of rotation is correct.

14. A method according to claim 3, wherein the upper or lower limits are broadened only if the direction of rotation is correct.

15. A method according to claim 2, wherein the upper or lower limits are broadened only starting from certain motor torques.

16. A method according to claim 3, wherein the upper or lower limits are broadened only starting from certain motor torques.

17. A method according to claim 2, wherein the motor torque limit curve is determined by road tests so as to demonstrate the intrinsic safety of the limit curve.

18. A method according to claim 4, wherein the upper or lower limits are broadened only starting from certain motor torques.

19. A power steering system for a motor vehicle comprising:
an electric motor for introducing a predefined additional torque so as to arbitrarily influence steering torque;
a device for acquiring a current manual torque;
a device for acquiring variables for the electric motor;
a device for acquiring a rotor position;
an electronic control unit for actuating the motor that is adapted to compute a target motor torque so that a desired actuating torque is established at a steering handle,
wherein the control unit is operable to minimize a control deviation between the target and actual actuating torques by computing a target motor torque, which can be established by suitable motor actuation.

20. A control unit for use in a power steering system having a steering handle comprising means operable to actuate an electric motor and to compute a target motor torque so that a desired actuating torque is established at the steering handle and a control unit operable to minimize a control deviation between a target and actual actuating torques by computing a target motor torque which can be established by suitable motor actuation.
